(19) United States
(12) Patent Application Publication
(10) Pub. No.: US 2008/0052082 A1
(43) Pub. Date: Feb. 28, 2008

(54) VOICE CONTROL METHOD

(75) Inventors: Wen-Wei Tsai, Taipei (TW); Chin-Peng Tsai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/842,959

(22) Filed: Aug. 22, 2007

(30) Foreign Application Priority Data
Aug. 23, 2006 (TW) 95130958

(51) Int. Cl. G10L 21/00

(52) U.S. Cl. 704/275; 704/E15.001

(57) ABSTRACT

A voice control method is provided, which includes the following steps. First, a sound signal is received, wherein the sound signal includes a voice signal and a predetermined signal. Next, and electronic device is used to filer the predetermined signal to acquire the voice signal from the sound signal. Next, the voice signal is compared with several sample signals. Finally, the electronic device implements a corresponding action according to the result of the voice comparison. When the voice comparison is successful, the electronic device implements a corresponding control command according to the corresponding sample signal of the voice signal. On the other hand, when the voice comparison fails, the electronic device displays a predetermined string on the frame.

### CROSS-REFERENCE TO RELATED APPLICATION

This application claims the priority benefit of Taiwan application serial no. 95130958, filed Aug. 23, 2006. All disclosure of the Taiwan application is incorporated herein by reference.

### BACKGROUND OF THE INVENTION

1. Field of the Invention

The present invention relates to a voice control method, and more particularly, to a voice control method including the steps of filtering a predetermined signal and conducting a voice comparison.

2. Description of Related Art

Most of the current electronic products such as a television, an air conditioner, an acoustic device employ a wireless remote control to enable a user to remotely control the electronic product without being limited by the region or directly contacting the electronic product.

The above conventional control method eliminates the trouble caused by the occupied and not free to hold the remote controller, the above conventional control method has no advantages.

### SUMMARY OF THE INVENTION

In view of the above, the present invention is directed to a voice control method, for enabling people to control an electronic device by utilizing a born talent, so as to facilitate people's daily life while improving the practicability and user-friendliness of the electronic device.

In order to achieve the above objective, the present invention provides a voice control method for the electronic device to compare and identify a corresponding sample signal of a voice signal from several sample signals. The voice control method comprises the following steps: receiving a sound signal, wherein the sound signal comprises a voice signal and a predetermined signal; filtering the predetermined signal after the above sound signal is received, in order to acquire the voice signal from the sound signal; then, comparing the acquired voice signal with several sample signals; finally, implementing a corresponding control command by the electronic device according to the corresponding sample signal of the voice signal when the voice comparison is successful, since each of the sample signals corresponds to a different control command respectively.

In the above voice control method, the predetermined signal is a sound source signal sent out by the electronic device when the sound signal is received by the electronic device in a preferred embodiment.

The above voice control method further comprises establishing a voice database to provide several sample signals before the sound signal is received in a preferred embodiment.

The present invention employs the voice control method including the steps of filtering a predetermined signal and then conducting a voice comparison, thus, even under the circumstance that the electronic device sends out sound source signals itself, the user can still control the electronic device by using voice without being interfered or limited, so as to facilitate the people's daily life while improving the practicability of the electronic device.

In order to make the aforementioned and other objectives, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a voice control method according to a preferred embodiment of the present invention.

FIG. 2 is a flow chart of establishing a voice database according to a preferred embodiment of the present invention.

### DESCRIPTION OF EMBODIMENTS

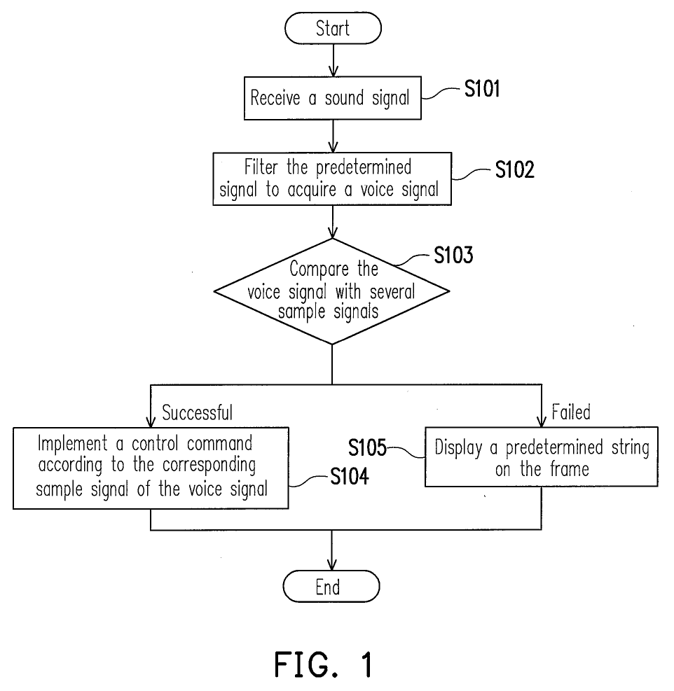

FIG. 1 is a flow chart of a voice control method according to a preferred embodiment of the present invention. The present embodiment is applicable for the electronic device to compare and identify a corresponding sample signal of a voice signal from several sample signals. Referring to FIG. 1, a TV set is taken as an example of the electronic device herein for auxiliary illustration. First, in Step S101, a sound signal is received by the electronic device (for example, a TV set), and the sound signal received by the electronic device includes a voice signal (for example, the sound sent out by the user) and a predetermined signal (for example, a sound source signal sent out by the electronic device, that is, the sound sent out by the TV set). Next, in Step S102, the predetermined signal is filtered (for example, the sound sent out by the TV set is filtered), in order to acquire the voice signal from the sound signal. Next, in Step S103, the acquired voice signal (for example, the sound sent out by the user) is compared with several sample signals. Since each of the sample signals corresponds to a different control command (such as, adjusting the volume, switching the channel) respectively. Thus, in Step S104, when the voice signal matches with one of the sample signals, in the words, when the signal comparison is successful, the electronic device implements the corresponding control command (for example, the TV set implements the action of adjusting the volume) according to the corresponding sample signal of the voice signal.

On the contrary, when the voice signal does not match with one of the sample signals, in the words, when the voice comparison fails, as in Step S105, the electronic device displays a predetermined string on the frame (for example, the TV set displays the string of “Voice identification fails” on the frame).

In the preferred embodiment of the present invention, the electronic device establishes a voice database before receiving the sound signal (before Step S101), so as to provide several sample signals.

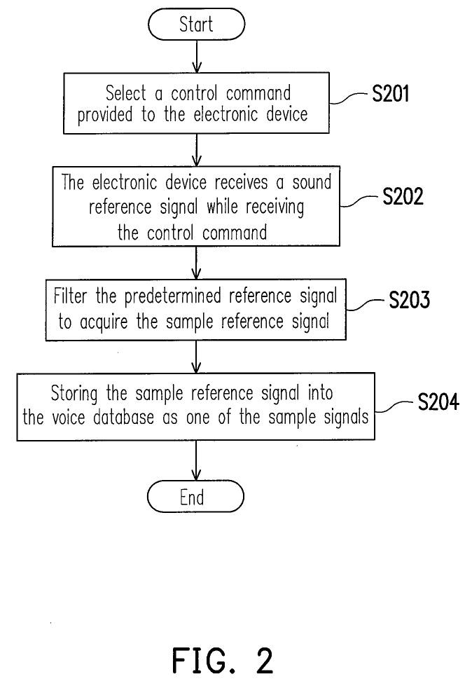

The steps of establishing the above voice database are shown in FIG. 2, and also the TV set is taken as an example of the electronic device herein for auxiliary illustration. In Step S201, since each of the sample signals corresponds to a different control command respectively, a control command is selected from the several control commands provided to the electronic device, (for example, any function key of the remote controller is pressed by the user to produce a control command to the TV set, wherein the control commands are different corresponding to different function keys on the remote controller). Next, as in Step S202, the electronic device receives a sound reference signal while receiving the above control command. The sound reference signal includes a predetermined reference signal and a sample reference signal, (for example, a sound to be stored into the voice database is sent out by the user while the user presses any function key on the remote controller, and the sound sent out by the user is equivalent to the sample reference signal, and the predetermined reference signal is a sound source signal sent out by the electronic device, that is, the sound sent out by the TV set).

Next, in Step S203, the predetermined reference signal (for example, the sound sent out by the TV set) is filtered from the sound reference signal, in order to acquire the sample reference signal. Finally, in Step S204, the sample reference signal is stored into the voice database as one of the several sample signals, and the above stored sample reference signal corresponds to the above control command, (for example, the sound sent out by the user is stored into the voice database as a sample signal, and at this time, the stored sample signal corresponds to the control command of the function key pressed by the user). Thus, after repeating the procedure shown in FIG. 2, several sample signals are established in the voice database of the electronic device, and each of the sample signals corresponds to a different control command respectively.

To sum up, the embodiment of the present invention uses a voice control method including the steps of filtering a predetermined signal and conducting a voice comparison, thus, even under the circumstance that the electronic device sends out sound source signals itself (for example, as described in the embodiment of FIG. 1, when the user controls the TV set by way of voice control, the TV set sends out sounds at the same time), the electronic device still can be controlled by way of voice control without being interfered or limited, so as to facilitate the people's daily life while improving the user-friendliness and practicability of the electronic device.

Although the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims and their equivalents.

What is claimed is:

1. A voice control method, applicable for an electronic device to compare and identify a corresponding sample signal of a voice signal from several sample signals, wherein each of the sample signals corresponds to a different control command respectively, the voice control method comprising:
receiving a sound signal including a voice signal and a predetermined signal;
filtering the predetermined signal to acquire the voice signal from the sound signal;
comparing the voice signal with the several sample signals; and
implementing a corresponding control command by the electronic device according to the corresponding sample signal of the voice signal.

2. The voice control method as claimed in claim 1, wherein the predetermined signal is a sound source signal sent out by the electronic device when the sound signal is received by the electronic device.

3. The voice control method as claimed in claim 1, further comprising a step of displaying a predetermined string on the frame by the electronic device, when the voice comparison fails.

4. The voice control method as claimed in claim 1, further comprising a step of establishing a voice database before the sound signal is received.

5. The voice control method as claimed in claim 4, wherein the step of establishing the voice database comprises the following steps:
selecting a control command from the control commands provided to the electronic device;
receiving a sound reference signal when the control command is received by the electronic device, wherein the sound reference signal comprises a predetermined signal and a sample reference signal;
filtering the predetermined reference signal to acquire the sample reference signal from the sound reference signal; and
storing the sample reference signal into the voice database as one of the sample signals, wherein the stored sample signal corresponds to the control command.

6. The voice control method as claimed in claim 5, wherein the predetermined reference signal is a sound source signal sent out by the electronic device when the sound reference signal is received by the electronic device.
